(19) United States
(12) Patent Application Publication
(10) Pub. No.: US 2007/0039564 A1
(43) Pub. Date: Feb. 22, 2007

(54) Muzzle

(76) Inventor: Alexia Steunou, Lausanne (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/564,038

(22) PCT Filed: Jun. 25, 2004
(86) PCT No.: PCT/CH04/00392

§ 371 Date: Jul. 12, 2006

(30) Foreign Application Priority Data
Jul. 10, 2003 (EP) 03405517.8

(51) Int. Cl. A01K 25/00; A01K 37/00

(52) U.S. Cl. 119/831; 119/712

(57) ABSTRACT

A muzzle is provided that comprises a restraining part designed to surround the mouth of an animal to prevent it from opening, and means for holding the part on the head. The part may be arranged in such a way that it opens elastically so long as it is subjected to a force less than a limit value, and it is locked if that force is exceeded.

The present invention concerns muzzles, used in particular to prevent dogs from biting. It is well known that, in certain circumstances, dogs can become aggressive. The muzzle prevents this aggressiveness from being expressed by a bite.

Traditional muzzles completely lack comfort for the animal. In particular, they prevent it from drinking, eating or else panting, which is important when effort is expended, specially to allow thermal regulation.

To overcome this disadvantage, document FR 2810503 proposes combining the muzzle with a leash, so that, so long as the animal shows normal behaviour, it can open its mouth without any difficulty. On the other hand, whenever it shows an aggressive nature and pulls on its leash, the muzzle fits tightly round the jaw and prevents the animal from opening its mouth.

This solution indeed offers many advantages by comparison with the other known solutions. However, it is completely ineffective if the master releases the leash. Now, it is precisely in such circumstances that the risk of accidents is greatest.

The aim of the present invention is to propose a muzzle allowing the animal on which it is fitted to eat, drink and pant in complete freedom, while preventing it from biting.

According to the invention, the muzzle comprises a restraining part designed to surround the animal's mouth to prevent it from opening, and means for holding the part on the head. It is characterized in that the restraining part is arranged in such a way that it opens elastically so long as it is subjected to a force less than a limit value, and it is locked if that force is exceeded.

It has, in particular, been observed that when the dog adopts a position of attack, it has its mouth closed, opening it suddenly only when it is preparing to bite. This sudden opening generates a force far greater than that applied when the animal is drinking or panting. Accordingly, only the animal's aggressive behaviour is prevented.

Advantageously, the restraining part includes a strap designed to surround the animal's mouth, and a locking mechanism co-operating with the strap and comprising:
a reel provided with a core to which one end of the strap is attached;
a frame on which the reel is mounted mobile in rotation and to which the other end of the strap is attached;
a spring linking the reel to the frame and arranged in such a way that said strap is wound on the reel when the spring is let down, while the spring is wound when the strap is unreeled;
a device for measuring the speed of rotation of the reel, and
a bolt co-operating with the speed measurement device and arranged so as to lock the reel when the speed exceeds a limit value corresponding to the force applied.

The speed measurement device and the bolt can be of the mechanical inertia type. More specifically, the speed measurement device contains an inertia component positioned elastically and mounted pivoting on the reel around an axis offset relative to its centre of gravity. The bolt includes a lock mechanism provided with:
teeth integral with the frame, and
a finger contained in the inertia component in its part opposite the pivoting axis relative to the centre of gravity, designed to co-operate with the teeth.

Accordingly, the finger can move freely relative to the teeth so long as the reel's speed of rotation is below a limit value. On the other hand, it engages with the teeth whenever the speed exceeds said limit and thus locks the reel.

As a variant, the speed measurement device contains an electric sensor, whereras the bolt contains an electromechanical transducer and a latch actuated by the transducer, which co-operates with the reel to lock it when the speed exceeds the limit value.

Advantageously, the sensor contains a generator equipped with a rotor and stator, one incorporating a magnet and the other a winding. The generator rotor is mounted rigidly on the reel. The winding contains two terminals connected to the transducer terminals. The generator and the transducer are arranged in such a way that the bolt is activated whenever the reel exceeds its limit speed of rotation.

Other advantages and characteristics of the invention will appear from the following description, made with reference to the appended drawing, in which:

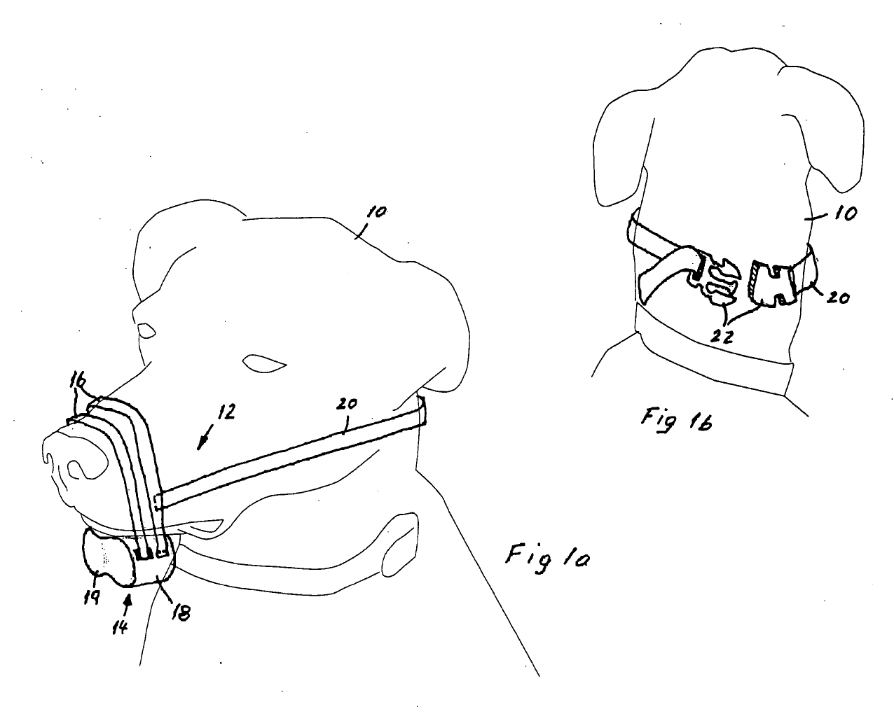

FIGS. 1a and 1b show a dog fitted with a muzzle as per the invention;

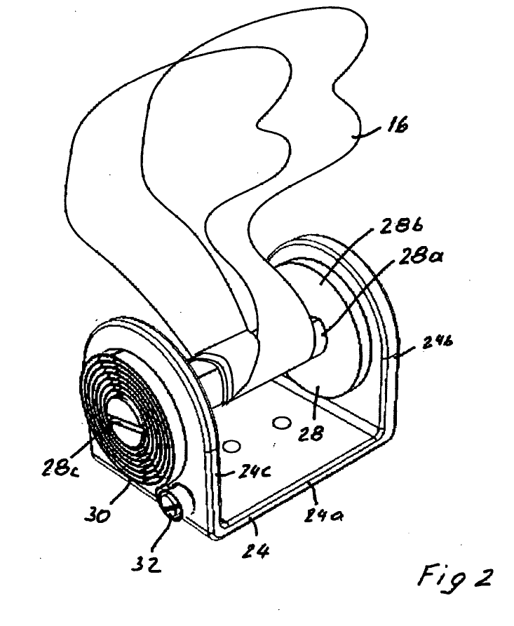

FIGS. 2 to 4 illustrate, in perspective, part of the muzzle in FIG. 1; and

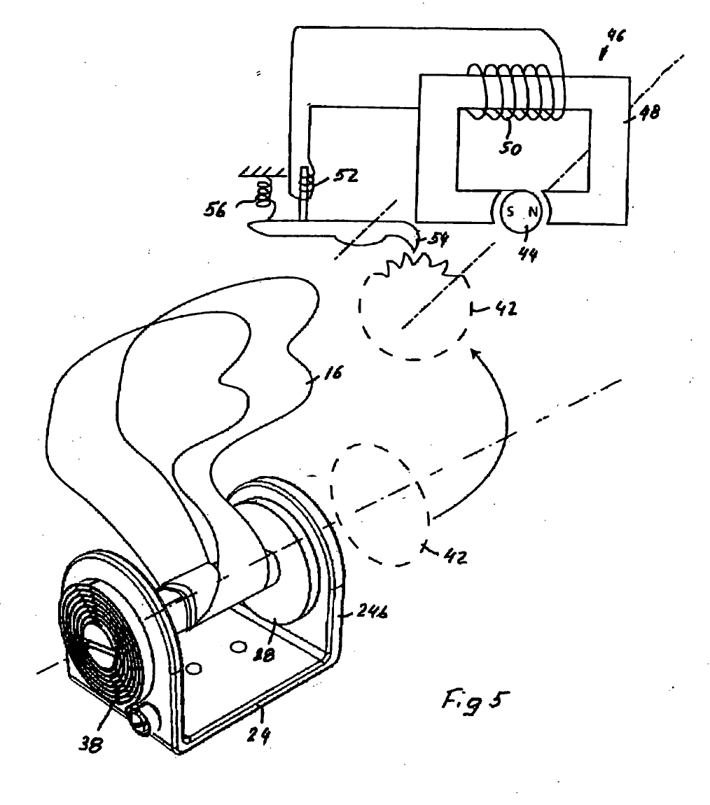

FIG. 5 shows the electrical diagram of a variant.

FIGS. 1a and 1b show a dog's head 10 fitted with a muzzle 12 as per the invention, in front and rear views respectively.

The muzzle 12 includes a restraining part 14 designed to surround the animal's mouth and comprising two straps 16 and a locking mechanism 18, provided with a box 19 alone visible on this figure, to which are attached the two ends of the straps 16, and means for holding the part 14 on the head 10, comprising a lace 20 and a clip 22, the latter being visible only on FIG. 1b.

The mechanism 18, which will be described in detail with reference to FIGS. 2 to 4, is arranged in such a way that, in the absence of restraint, the straps 16 tend to wind up in the box 19. Accordingly, to place in position the muzzle 12, all that is needed is to pull on these straps 16 to form two adjacent loops in which the animal's nose is inserted, then run the lace 20 behind the ears and close the clip 22.

FIGS. 2 to 4 show part of the mechanism 18, performing the locking function for one of the straps 16. The other part is identical. It has therefore not been shown.

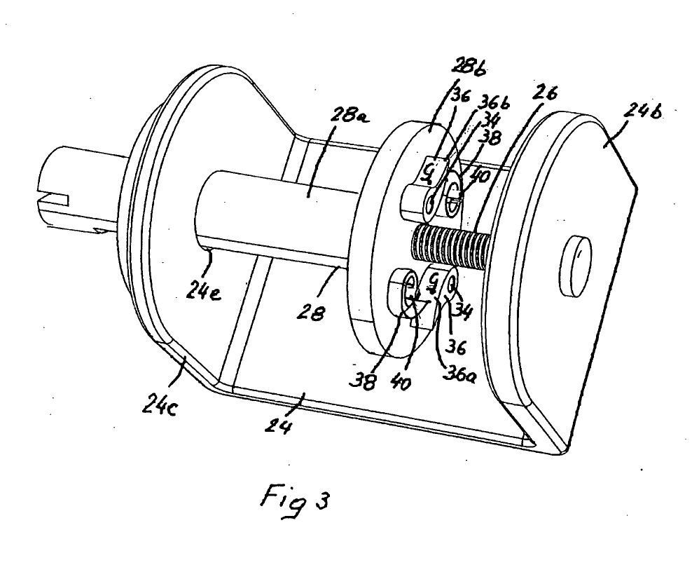

One can see on these figures a U-frame 24, provided with a base 24a and two arms 24b and 24c parallel to one another and perpendicular to the base. The arms 24b and 24c are pierced with coaxial holes 24d and 24e respectively (FIG. 3). In hole 24d, tapped, is inserted a threaded shaft 26, which bears a reel 28 fitted with a core 28a inserted on shaft 26 and a flange 28b adjacent to arm 24b. The core 28a is hollow and inserted on the shaft 26. It passes right through hole 24e and goes beyond arm 24c.

The inner end of a coil spring 30 is mounted on the part of the core 28a, by insertion in a slot 28c (FIG. 2). It is attached by its outer end to the outer wall of arm 24c, by means of a slotted stud 32.

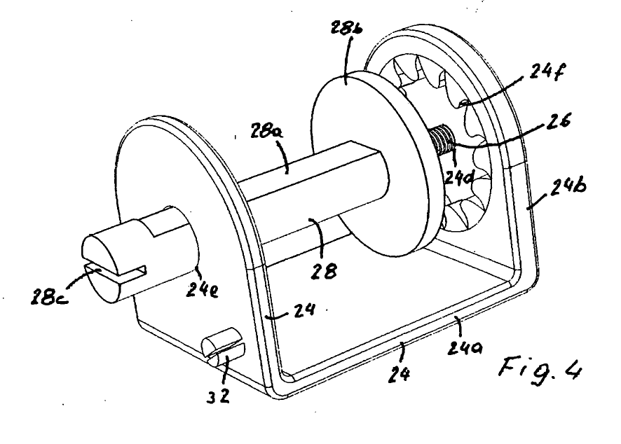

As can be seen on FIG. 4, arm 24b is provided with internal teeth 24f consisting of gullet teeth and which extend from the edge of arm 24b toward its centre, concentric with shaft 26 and the side of flange 28b.

Flange 28b carries two studs 34, visible on FIG. 3, each supporting a click 36. Leaf springs 38 are attached by one of their ends to the body 36a of click 36, by insertion in a slot, and by the other end to flange 28b by means of a slotted stud 40. The springs 38 are advantageously attached by clamping in one of the slots, at either of their ends.

The clicks 36 pivot on the flange 28b around an axis parallel to the axis of the reel 28. They contain a latch 36b, located at the end of body 36a and arranged so as to co-operate with the teeth 24f, as will be explained further on.

The centres of gravity of the clicks 36, identified by the letter G, are located between the pivoting axis and the latch 36b. Without restraint, the springs 38 position the clicks 36 so that they can move freely relative to the teeth 24f. If the reel 28 turns, centrifugal force causes the latches 36b to move outward, the extent of this movement increasing with the speed. For a limit value of the speed, the clicks come into contact with the teeth, thus locking the reel.

The strap 16 is attached by one end to the core 28a of reel 28 and by the other end to the base 24a of frame 24 (FIG. 2). The spring 30 is arranged in such a way that it is relaxed when the strap is wound on the core 28b.

Tension exerted on the straps 16 causes them to unwind from the reel 28, the speed of rotation of the reel 28 increasing with the force exerted. This tension allows extraction of the straps so long as the speed of rotation remains below the limit value. As soon as this value is exceeded, the latches 36b engage with the teeth 24f where they are fastened and block rotation, and hence the extraction of strap 16. Accordingly, the restraining part 14 works in a similar manner to car seat belts.

To place the muzzle in position, simply stretch the straps 16 gradually so as to extract them from the box 19, thus forming two loops placed over the animal's nose. After releasing the straps 16, the lace 20 is placed behind the animal's ears. It is held in position by pushing in the clip 22. Clip 22 is mounted with one of its parts sliding over the lace 20, so as to allow its length to be adjusted.

Note that the muzzle could also work with a single strap and a single reel. In this case, however, the strap must slide over the animal's nose, which is likely to cause movement of the mechanism 18. It is also possible to provide for a mechanism 18 containing two reels, the two ends of strap 16 being integral with one of the reels. The solution to be chosen will depend in particular on the animal's size.

In the variant shown schematically in FIG. 5, we find the strap 16, the frame 24, the reel 28 and the spring 38. The core 28a of reel 28 is extended, as shown schematically by an axis line, equally beyond arm 24a of the frame 24, and carries a ratchet wheel 42 and a rotor 44. The rotor 44 belongs to a generator 46 also incorporating a stator 48 provided with a winding 50. An electromagnet 52 and a click 54 are placed in the vicinity of wheel 42. The electromagnet 52 co-operates with a magnetic core comprised in the click 54. It is electrically connected to the generator winding 50. In addition, a spring 56 co-operates with the click 54 so as to keep it remote from the wheel 42.

So long as the signal at the terminals of the electromagnet generates a force less than that of the spring 56, the click remains in its rest position. As soon as this limit is exceeded, the click tilts and engages with the teeth of the wheel 42, thus locking the wheel. Advantageously, the teeth of this wheel are arranged so that the click 54 remains engaged with the teeth until the tension applied to the strap is interrupted.

The signal applied to the electromagnet 52 is obtained by tension on the strap 16, which causes the reel 28 to rotate, and with it the rotor 44, thereby inducing a signal in the stator 48. This occurs when the animal tends to open its mouth suddenly.

Whether the first or the second embodiment is adopted, the strap is locked in its movement, preventing opening of the mouth and hence biting. Opening during panting or when the animal is drinking, on the other hand, has no effect on the mechanism 18, accordingly in no way affecting such movements.

The two embodiments described can still be the subject of numerous variants, although without going beyond the scope of the invention. It would, for example, be possible to develop an even more sensitive device, making use of sensors and control electronics to determine, according to the animal's behaviour, when the restraining part must be locked.

In another variant, it is conceivable to use materials the coefficient of elasticity of which increases sharply when they are subjected to major mechanical stress. A plastic material having such a property is, for example, sold by the Dupont de Nemour firm under the Hytrel® brand.

Accordingly, thanks to the characteristics of the devices described, it is possible to protect the public by means of an effective muzzle, while ensuring satisfactory comfort for the animal wearing it.

1. A muzzle comprising:
a restraining part designed to surround the mouth of an animal to prevent it from opening, and
means for holding the restraining part on the head,
the restraining part being arranged such that it opens elastically so long as it is subjected to a force below a limit value, and is locked if that force is exceeded.

2. The muzzle according to claim 1, wherein the restraining part includes a strap designed to surround the animal's mouth and a locking mechanism cooperating with the strap, the locking mechanism comprising:
a reel provided with a core to which one end of the strap is attached;
a frame on which the reel is rotatably mounted and to which the other end of the strap is rigidly attached;
a spring linking the reel to the frame and arranged in such a way that the strap is wound on the reel when the spring is let down, while the spring is wound up when the strap is unreeled;
a device for measuring the speed of rotation of the reel; and
a bolt cooperating with the speed measurement device and arranged so as to lock the reel when the speed exceeds its limit value.

3. The muzzle according to claim 2, wherein the speed measurement device and the bolt are of the mechanical inertia type.

4. The muzzle according to claim 3, wherein the speed measurement device contains an inertia component positioned elastically and mounted pivotably on the reel around an axis offset relative to its center of gravity, and wherein the bolt includes a lock mechanism provided with:
teeth integral with the frame, and
a latch contained in the inertia component in its part opposite the pivoting axis relative to the center of gravity and designed to cooperate with the teeth.

5. The muzzle according to claim 2, wherein the speed measurement device contains an electric sensor and the bolt contains an electromechanical transducer and a bolt actuated by the transducer, and cooperating with the coil to lock it when the speed exceeds a limit value.

6. The muzzle according to claim 5, wherein the sensor contains a generator equipped with a rotor and a stator, one incorporating a magnet and the other a winding, the rotor being mounted rigidly on the reel, and the winding containing two terminals connected to the terminals of the transducer, the generator and the transducer being arranged in such a way that the bolt is activated whenever the reel exceeds a limit speed.

7. The muzzle according to claim 2 further comprising two straps and two locking mechanisms, each locking mechanism cooperating with one of the straps.
